(19) United States
(12) Patent Application Publication
(10) Pub. No.: US 2002/0143652 A1
(43) Pub. Date: Oct. 3, 2002

(54) Method of doing business using on-line skill-based gaming

(76) Inventor: Justin F. Beckett, Chapel Hill, NC (US)

Correspondence Address: JINAN GLASGOW, P O BOX 28539, RALEIGH, NC, 276118539

(21) Appl. No.: 10/035,887

(22) Filed: Dec. 31, 2001

Related U.S. Application Data
(63) Continuation-in-part of application No. 09/818,809, filed on Mar. 27, 2001.

(51) Int. Cl. G06F 17/60; G06F 19/00

(52) U.S. Cl. 705/26; 705/14; 463/42

(57) ABSTRACT

A method of doing business using on-line knowledge and skill-based gaming wherein a multiplicity of users play simultaneously and where revenue is generated based on the number of players who visit the website where the game is hosted and played.

### CROSS-REFERENCE TO RELATED APPLICATIONS

This non-provisional utility patent application claims the benefit of one or more prior filed co-pending non-provisional applications; a reference to each such prior application is identified as the relationship of the applications and application number (series code/serial number): The present application is a Continuation-In-Part of application 09/818,809 filed Mar. 27, 2001 by Beckett, et al.

### BACKGROUND OF THE INVENTION

(1) Field of the Invention

The present invention relates generally to the area of on-line gaming and, more particularly, to skill based on-line gaming.

(2) Description of the Prior Art

Typically, it is known in the prior art to provide a database for remote, online participation by players of a game. Additionally, it is known to use a method for multiple user interactive game playing, including multiple concurrent playing, including feedback regarding relative skill and/or results level. Finally, server-based wide area network gaming is known, especially including prizes and redemption thereof based on successful play.

U.S. Pat. No. 6,174,237 issued Jan. 16, 2001 to Stephenson for Method for a game of skill tournament teaches a game that is played over an interactive computer system, and claims it to be challenging while providing feedback to a player regarding his/her comparable skill level versus other players. The game comprises a qualifying round played against a computer; in a playoff round multiple players play simultaneously against a computer and rewards are given for highest points.

U.S. Pat. No. 5,779,549 issued Jul. 14, 1998 to Walker, et al. for Database driven on-line distributed tournament system teaches a game wherein remotely located players participate through devices connected to a central controller. The system includes software and hardware to implement the following steps: a) identifying player, b) responding to payment of entry fee by player, c) accessing a database to store information generated by player, and d) awarding a prize to player for performance achievement. Further steps could include elimination or disqualification of players in tournament rounds.

U.S. Pat. No. 5,695,400 issued Dec. 9, 1997 to Fennell Jr. et al. for Method of managing multi-player game playing over a network teaches a method of managing user inputs and displaying outputs in a multi-player game played on a plurality of terminals on a network, and includes a) transmitting a game challenge, such as a trivia question, to the terminals, b) receiving game response from the terminals, c) assigning each responding terminal a priority rank according to response signals, such as elapsed time, d) determining which terminal has highest rank, and e) sending signals to responding terminals assigning them respective degrees of control of game in accordance with their ranks.

U.S. Pat. No. 6,007,426 issued Dec. 28, 1999 to Kelly et al. for Skill based prize games for wide area networks teaches a prize redemption system that includes a server in communication with the game apparatuses to form a wide area network that may include the Internet. The game is provided on a game apparatus in exchange for monetary input and prized credits are awarded based on game outcome. Players may then select a prize corresponding to credit amount from a prize selection menu, and players are then issued a ticket redeemable for that specific prize.

U.S. Pat. No. 5,734,413 issued Mar. 31, 1998 to Lappington et al. for Transaction based interactive television system teaches an interactive television system, where a signal is received and decoded by a settop device which sends an infrared decoder signal to a handheld device. The system stores data for viewers, such as player information and scores, and allows many interactive programs to run concurrently over extended periods of time.

U.S. Pat. No. 6,146,273 issued to Olsen on Nov. 14, 2000 for a Progressive jackpot gaming system with secret bonus pool describes a method of operating of controller-based progressive gaming system having a plurality of gaming machines wherein each gaming machine generates unit bet information indicative of a number of unit bets supplied to a machine for playing a game.

U.S. Pat. No. 5,916,024 issued to Von Kohorn on Jun. 29, 1999 for a System and method of playing games and rewarding successful players describes a system and method for evaluating responses to broadcast programs, such as television programs, includes an instructional signal modulated onto a signal transmitted concurrently with the television program, or time-multiplexed with television signals. At each of a plurality of remote receiving stations, one or more members of a remote audience has the opportunity to respond to a task or situation presented in the television program by entering a response vocally or on a keyboard. The system may include a video game machine suitable for playing commercially available games such as an NINTENDO game or a SEGA game, and wherein such game may be played back from a recording. Multiple players at a common game may be ranked in their performance, and games may be interrupted for a sponsor's message, and wherein a response to the message may serve as a basis for an enhanced score.

U.S. Pat. No. 5,713,795 issued to Kohorn on Feb. 3, 1998 for System and method of communication with authenticated wagering participation teaches a system and method for wagering and for evaluating responses to broadcast programs, such as television programs, includes an instructional signal modulated onto a signal transmitted concurrently with the television program, or time-multiplexed with a television. For playing a lottery, numbers are entered at the remote stations and are stored at a central facility for verification upon presentation of lottery tickets. The program may be presented live conducted by a host at a central station, or by a prerecorded message accessible by telephone from a remote station with regulation from a central station.

A variety of games are offered for play via the Internet, including trivia games. The trivia games currently playable via the Internet offer a variety of trivia categories, such as TV, music, science, art/literature, sports, etc. Some of these trivia game sites offer the user the possibility of choosing a category and/or accumulate points earned during play. However, none of these Internet gaming sites provide music trivia games for the purpose of selling music or music-related products. Several types of games exist to aid in the selling of products. However, these games are static and are normally renewable only by considerable alteration of the game mechanisms. However, knowledge-based skill games, and especially trivia-based skill games, are easily renewable by the addition of new knowledge, and thus are dynamic games with which the user will return even after considerable play because the game continues to remain novel.

Furthermore, no prior art teaches a method of doing business that uses a knowledge- and skill-based game as a means for revenue generation on its own from a website. More specifically, no prior art teaches a method of doing business that uses knowledge-based gaming to sell or advertise products. Thus, there remains a need for a method of doing business that uses a knowledge- and skill-based game as a means for revenue generation on its own from a website.

### SUMMARY OF THE INVENTION

The present invention is directed to a method for using on-line knowledge and skill-based gaming wherein a multiplicity of users play simultaneously from remote locations.

Also, the present invention is directed to a method of doing business using on-line knowledge and skill-based gaming wherein a multiplicity of users play simultaneously and where revenue is generated from sponsorship and/or advertising that is related to the number of players who visit the website where the game is hosted and/or played.

Accordingly, one aspect of the present invention is to provide a method for using on-line knowledge and skill-based gaming wherein a multiplicity of users play simultaneously from remote locations.

Another aspect of the present invention is to provide a method of doing business using on-line knowledge and skill-based gaming wherein a multiplicity of users play simultaneously and where revenue is generated from sponsorship and/or advertising that is related to the number of players who visit the website where the game is hosted and/or played.

These and other aspects of the present invention will become apparent to those skilled in the art after a reading of the following description of the preferred embodiment when considered with the drawings.

### BRIEF DESCRIPTION OF THE DRAWINGS

FIG. 1 is a schematic data flow diagram for a conceptual data model of a preferred embodiment according to the present invention.

### DETAILED DESCRIPTION OF THE PREFERRED EMBODIMENTS

In the following description, like reference characters designate like or corresponding parts throughout the several views. Also in the following description, it is to be understood that such terms as “forward,” “rearward,” “front,” “back,” “right,” “left,” “upwardly,” “downwardly,” and the like are words of convenience and are not to be construed as limiting terms.

A preferred embodiment according to the present invention provides a method for using on-line knowledge and skill-based gaming wherein a multiplicity of users play simultaneously from remote locations. Revenue is generated from either pay-for-play by each user or by sponsorship and/or advertising that is related to the number of players who visit the website where the game is hosted and/or played.

The on-line gaming platform includes knowledge- and skill-based games such as trivia-based and/or memory-based games with audio and visual components to attract the user and maintain the users attention. The knowledge- and skill-based games include, by way of example and not limitation, sports-related, law-related, medicine-related, history-related, science-related, religion-related, entertainment-related, music-related, movie-related, TV-related, cartoon-related, art-related, fashion-related, language-related and other types of categories that would be attractive to a wide audience or pool of potential players or users of all ages, backgrounds, knowledge, and skill sets.

Additionally, the knowledge- and skill-based games may be memory matching or concentration for a variety of categories.

Furthermore, the games may include trivia having a multiplicity of prompts and responses or questions with answers. Trivia games, in particular genre-specific trivia games, are advantageous because most persons are attracted to a particular genre that is related to their particular age, culture, and background, and therefore will tend to stay engaged with a game longer if the game is dealing with a genre of any subject they prefer. Contrarily, trivia games in which the user is forced to answer questions from a non-preferred genre often result in the user quitting the game prematurely; thus, the platform used for the present invention is advantageous for attracting users who will likely be repeat players of the games offered on the website. The games are also designed to provide questions for different skill levels, thus providing the user with a satisfactory rate of success and ensuring that the user will continue to play the game and not quit prematurely. Additionally, the regular scheduling of games and contests will ensure a consistent level of repeat visits to the gaming site. The on-line gaming system according to the present invention is internet-based, with a front end for providing the user interface and a back end for providing game operation. At least one user, preferably a multiplicity of users, accesses the front end through a website that is visible on at least one computer screen, preferably a multiplicity of remote computer screens simultaneously. The front-end, including a user interface, provides the questions to the at least one user, and is interactive, such that the user(s) can provide answers to the questions in addition to performing other interactions, such as choosing the genre of music about which to answer question. Preferably, multiple users play the gaming system simultaneously. Also, these multiple users may play the game in a coordinated fashion, such as tournaments or two-player matches. In a preferred embodiment, the user interface is always conspicuous for the user(s) on a computer screen.

In one embodiment of the present invention, revenue is generated for the website host by taking a percentage of fees paid by each of the player(s) to enter a given game. For example, the host may take between about 5% to 50%, preferably 25% of the fees paid by each player(s) for each game; where a multiplicity of players are competing, the winner, i.e., the player with the highest score, wins the remaining balance of the fees paid by each player for that game. In this embodiment, the prize is a cash prize that is related to the knowledge- and skill-based game; for example, the more difficult or challenging the game, the larger the entry fee per player and the larger the prize.

In an alternative embodiment, revenue is generated for the website host by advertising and/or sponsorship that is related to the expected audience for a given type of game and category within each game type. User information is gained through the play of the game itself, e.g., where questions that relate to brand awareness generate responses from the players that is useful to the advertiser and/or sponsor. In another example, the producer of an entertainment program or television show would sponsor or subsidize the games and prizes relating to a category that corresponds to or that relates to that particular television show. The sponsor gains recognition on the gaming website and it can gain feedback regarding each player's interests and awareness of products, etc. that may be targeted expressly for a given audience based upon each players responses to the knowledge- and skill-based game prompts or questions.

In still another embodiment, revenue may be generated on a subscription basis, wherein each user pays a periodic fee, e.g., a monthly fee, for unlimited play of certain games hosted by the website. Over that same period, winners are determined based upon play scores during the period, either individual best and/or collective or cumulative points. As with the foregoing embodiments, players can compete directly or indirectly over a time period for a given game, category, etc.

In yet an alternative embodiment, where the revenue is generated from sponsorship or advertising based upon connection with another website, the user gaming interface is not conspicuous when the user(s) is actively browsing the website, such as when shopping for products on a product-related website, but remains in the background. The gaming interface becomes conspicuous during user waiting periods, such as when the user(s) has placed an order and is waiting for the order to be processed (checkout). During these time periods, the gaming interface will appear on a computer screen and prompt the user(s) to initiate play of or resume playing the knowledge and skill-based games. By entertaining the user(s) during these waiting periods, the game prevents user boredom and thus further gratifies the user experience at the site. Additionally, the user(s) might be prompted by the game to order some other item prior to leaving the site.

The user interface connects at least one remote user to a back end, which includes a database, preferably a proprietary database, and a multiplicity of game types. More particularly the user interface is provided by an application service/server provider (ASP) model, wherein the at least one remote user is directly connected to and/or is linked via another website to the front end website, including the ASP, for connecting with the database and its contents. In the preferred embodiment, the database contains a multitude of questions with answers, preferably greater than 20,000 questions with answers, that have been collected and have been independently confirmed to be accurate questions and answers.

In the preferred embodiment, the back end provides the game rules, game scoring, game user history, and different game questions from a database. The database includes a platform for hosting different types of knowledge- and skill-based games which can be hosted on a website and played by a multiplicity of users simultaneously from remote locations that access the host website via an on-line connection with the Internet. The database provides accurate prompts and responses or questions with answers chosen from a broad selection of knowledge and skill based games, including for example trivia games. In a preferred embodiment, the broad trivia selection includes a broad selection of sports-related, law-related, medicine-related, history-related, science-related, religion-related , entertainment-related, music-related, movie-related, TV-related, cartoon-related, art-related, fashion-related, language-related and other types of categories that would be attractive to a wide audience or pool of potential players or users of all ages, backgrounds, knowledge, and skill sets; this selection includes a broad selection of prompts and responses or questions with answers from each category. The broad selection of categories ensures that a user will find a category of his/her preference, while the broad selection of questions with answers in each category provides that the user will not repeat a question frequently. Preferably, the selection of questions with answers in each category is such that the chance of a user repeating a question prior to completing 1000 questions is minimal. The database selections are also continuously augmented with new trivia, such that the chance of repeating a question continues to decline.

The database, in addition to providing text questions, may also provide sound bytes and visual clips to enhance the enjoyment of the game. The sound bytes may be musical bytes such as excerpts from songs or other musical renditions, or may be non-musical sounds such as speech. Because the user is music-oriented, the use of musical bytes will enhance the enjoyment of playing the game. The visual clips may also be used to enhance the user's experience. Finally, videos or segments thereof, which combine musical bytes and visual clips, may be used.

The gametypes used in the preferred embodiment are trivia-based. Although simple question and answer games are provided, other games that utilize trivia, such as crossword puzzles, short-term memory games, and audio and/or visual recognition games may be provided. Some examples follow:

### EXAMPLE 1

Trivia Challenge.

The Trivia Challenge game consists of ten multiple-choice trivia questions to be answered within a two-minute period. Each question has an answer set of five options, with one of the choices being the clear, correct answer. While playing the game, players have the option of listening to sound bytes or video segments.

### EXAMPLE 2

Memory Match.

Memory Match is a variation of the popular game of Concentration. Each game features eight pairs of unrevealed matching tiles of each category. The player clicks on a tile, revealing the hidden picture. The player then clicks on a second tile, trying to match the first. The object of the game is to successfully pair all the tiles in the least number of tries.

### EXAMPLE 3

Picking Hits.

Picking Hits is an event-driven game that measures the player's ability to anticipate popular music, movie, or entertainment trends. Players select a category, and then answer a number of questions related to the success of particular artists within that category. The trends that the player may predict include video or record sales, single sales, TV/movie/radio airplay, video airplay, number of downloads and largest sales gains. After a specified period (usually between one and four weeks) all the players' predictions are scored and ranked based on accuracy.

### EXAMPLE 4

Name The Artist.

Name The Artist is a music identification game consisting of a series of ten sound bytes taken from the player's chosen musical category. After listening to the sound byte, the player chooses the correct answer from an answer set of five options within a set period of time.

### EXAMPLE 5

Music ShufflePuzzle.

The Music ShufflePuzzle is a music-related puzzle. The player selects a music category from which a picture (likely a photograph of an artist or album cover) is fragmented into a scrambled tile puzzle. The player then uses their mouse to slide the tiles to correctly reconfigure the picture. The game is timed and the player earns points based on the speed of completing the puzzle.

### EXAMPLE 6

Crosswords.

The Crosswords are category specific crossword puzzles. The player attempts to complete a puzzle consisting of 75 clues and answers relating to the chosen category. The game features an overall timer function, and a way for the player to get letter or word clues. The player earns points for completing the puzzle quickly with points being subtracted for the use of clues.

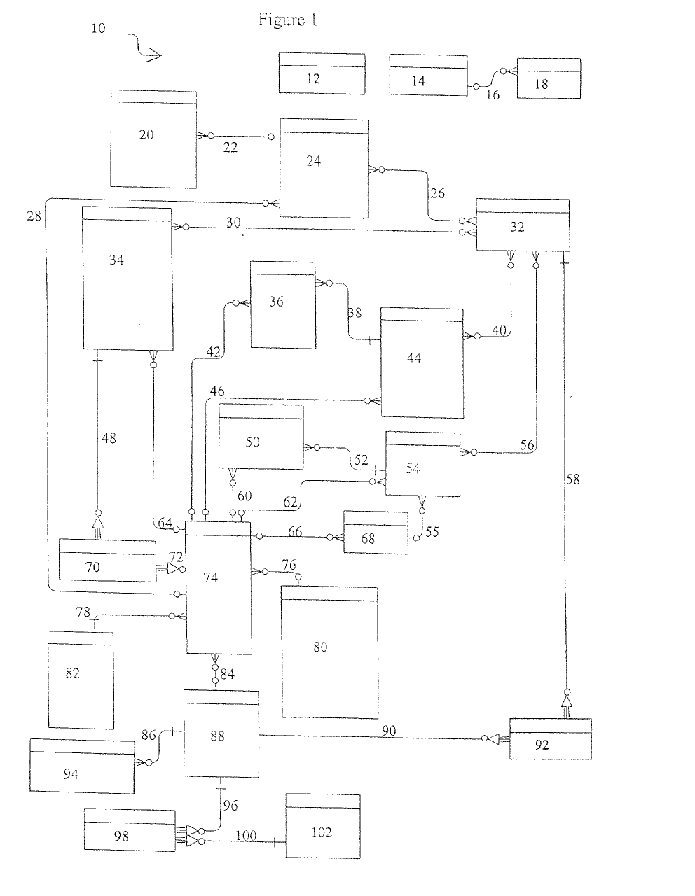

Referring now to the drawings in general, the illustrations are for the purpose of describing a preferred embodiment of the invention and are not intended to limit the invention thereto; this embodiment is a music-related knowledge-and-skill-based on-line gaming system. A schematic data flow diagram for a conceptual data model of a preferred embodiment according to the present invention, generally referenced as 10, is shown in FIG. 1. In his model, Global Settings Table 12 provides the Global Picture Path and Global Song Path. The GamerLog Table 18 generates the GamerLogID and allows logging on via the Log Entry. The GamerLog Table transmits the GamerLogs via the GamerLogs Junction 16 to the Gamer Table 14. The Gamer Table provides the Gamer Identification and Gamer IP Address. These components combined are the Global Independent Data Structure and are not directly part of the functioning game. The Users Table 74 contains the individual UserIds, comprised of the user's first and last name, email address, company, department, telephone number, fax number, username, and password. This UserID is linked to an Address Table 82, which contains the user's physical address information. Data is transmitted between the Users Table and the Address Table via the UserAddress Junction 78. The Users Table is also linked via the UserType Junction 76 to the UserType Table 80, which provides information on the UserTypeID, including the UserTypeName, the UserTypeDescription, The SystemAdminFlag, the SystemReviewerFlag, the SystemEditorFlag, the SystemAuthorFlag, the SiteAdminFlag, the SiteUserFlag, and the SiteReportFlag. The Users table interfaces with the Site Table 88 via the SiteUsers Junction 84. The Site Table provides the SiteID, the SitePrefix, the SiteName, the SiteDescription, the SiteRootDirectory, and the SiteComments. The Site Table interfaces with the SiteImages Table 94 via the SiteImages Junction 86 that provides SiteImagesID, SiteImageFileJunction and SiteImageDescription. The Site Table also interfaces with the SiteBannerJunc Table 98, which provides, via the BannerSite Junction 96, the Banner Rotation Constant and the Banner Rotation Timing. The SiteBannerJunc Table interfaces through the SiteBanner Junction 100 with the SiteBanners Table 102, which provides the BannerID, BannerType, BannerFileJunction, and BannerTitle. The Site Table also communicates with the SiteCategoryJunc Table 92, via the SiteCat Junction 90 to provide the CatPercent. The SiteCategoryJunc Table also communicates, via the CateSiteJunction 58, with the Categories Table 32, which provides the CategoryID, CategoryName, and Category Description.

The Users Table communicates with several Question/Answer Tables, depending on the type of game being played. Thus, the Users table can communicate with the CrossWord Table 24 via the AuthorCrossword Junction 28, TriviaQuestions Table 34 via the AuthorTrivia Junction 64, the NameArtists Table 36 via the AuthorNameArt Junction 42, the CorrectNames Table 50 via the AuthorConnect Junction 60, the Songs Table 44 via the AuthorSongs Junction 46, the Pictures Table 54 via the AuthorPictures Junction 62, the PickingHits Table 68 via the AuthorPickHits Junction 66. The CrossWord Table provides the CrosswordID, the Cross Title, the CrossSettingsInt, the CrossDescription, the CrossUnitLength, the CrossUnitHeight, and the CrossStorage String. The CrossWord Table also interfaces with the Categories Table via the CrosswordCat Junction 26, and with the CrosswordHints Table 20 via the CrossHint Junction 22. The CrosswordHints Table provides the CrosswordHintID, the Hint, the Answer, the Source, the Location X, the Location Y, and the Length. The TriviaQuestions Table provides the QuestionID, the Question, Answers 1 through 5, the Difficulty Level, the Source, the Active Flag, and the Approved Flag. The TriviaQuestions Table also interfaces with the Categories Table via the QuestionCat Junction 30. The NameArtist Table provides the NameArtistID and Answers 1 through 5. The Songs Table provides the SongID, the SoundFileJunction, the SoundFileLength, the Artist, the Song Title,the Album Title, the Publish Year, and the ScanCode. The Songs Table also interfaces with the Categories Table via the SongCatJunction 40. The NameArtist Tble and the Songs Table interface via the NameSongs Junction 38. The CorrectNames Table provides the CorrectNamesID, the CorrectName, IncorrectName1, and IncorrectName2. The Pictures Table provides the PictureID, the PictureType, the PictureFileJunction, and the PictureTitle. The Pictures Table also interfaces with the Categories Table via the PicCatJunction 56. The ConnectNames Table and the Pictures Table connect via the NamePictures Junction 52. The PickingHits Table provides the PickingHitsId and the Question to the Users Table via the AuthorPickhits Junction 66. The PickingHits Table also interfaces with the Pictures Table via the PickHitsPic Junction 55.

The Users Table also interfaces with the RevComm Table 70, which provides ReviewerComments via the RevCo Junction 72. The RevComm Talbe interfaces with the TriviaQuestions Table via the ReviewerComments Junction 48.

The controls, commands, and other interactions of the system are provided by software. The gaming system and user may interact in various ways. For example, the game may prompt the user to perform a task or some other action, such as requesting the user to choose the correct response to a question. When the user responds, the system replies appropriately. Alternately, the gaming system may not prompt the user, but simply provide an opportunity for input by the user, to which the system then responds with an output.

As is demonstrated in FIG. 1, the system can provide trivia questions, artist names, questions, songs questions, picture questions, and other types of questions from a particular category. At some time during play, preferably after completion of a round, the system displays to the user(s) a list of music products related to the category being played or just played, such as CD music recordings by an artist or group just heard during the round, and asks the user(s) if he/she would like to purchase one or more of the items displayed. The user(s) can then choose from several options, including elect to purchase one or more of the items, add them to a shopping list, and continue to play the game.

In general, the trivia-based games are genre-specific, for the reasons cited previously. Namely, where the gametype is music or the game comprises music prompts and responses, most persons are attracted to a particular genre of music, and therefore will tend to stay engaged with a game longer if the game is dealing with a music genre they prefer. Therefore, the genres are predetermined styles of music such as Rock, Jazz, Country, Rap, Hip-Hop, Rhythm and Blues, Alternative, Latin, Heavy Metal, Punk Rock, Techno, Surf, Disco/House, Beach, Gospel, Swing, Drummers, Zydeco, Salsa, Soul, Classic Soul, Classic Rock, Blues, Reggae, Dance Hall, Bluegrass, Rockabilly, Big Band, Doo Wop, Indie Rock, Opera, Classical, International, Oldies, Christian, Religious, Electronica, Instrumental, Lyrical, and the like. Alternately, other non-music-style categories may be included, such as music trivia related to advertising, products, time-periods, musicians, musical groups, nationality, and the like. Examples include Pop, #1 Hits, 90's Music and Beyond, 80's Music, The Beatles, Teen Scene, Alternative, Music Masters, College Radio, Women in Rock, Masters, One Hit Wonders, Movie Music, Glam Rock, Guitar Gods and Goddesses, Family Affairs, Singers & Standards, The Rolling Stones, '50s & '60s, Bass Players, Kings & Queens of the Keys, Crimes & Misdemeanors, Singers who act and Actors who sing, Love Songs, Grateful Dead, Michael Jackson, Madonna, Classic Covers, Elvis, Billboard #1 Hits, Divas, and Player's Choice. A random category may also be provided.

Certain modifications and improvements will occur to those skilled in the art upon a reading of the foregoing description. All modifications and improvements have been deleted herein for the sake of conciseness and readability but are properly within the scope of the following claims.

1. A method for hosting on-line gaming comprising the steps of: providing a computer-based game that a multiplicity of users can access via an Internet website displayed a multiplicity of respective remote computers.

2. A method of doing business using on-line knowledge and skill-based gaming wherein a multiplicity of users play simultaneously and where revenue is generated based on the number of players who visit the website where the game is hosted and played.

3. The method according to claim 2, wherein the revenue is based on advertising.

4. The method according to claim 2, wherein the revenue is based on sponsorship.

5. The method according to claim 2, wherein the revenue is based on pay-for-play by each of the multiplicity of users.

6. The method according to claim 2, wherein the computer-based game includes the steps of
a) providing a gaming system that includes a front end for user interface, a database, and a game;
b) each user logging onto the game from at least one remote computer;
c) verifying by a database each user's userid and password;
d) beginning a game session by selecting a game category;
e) providing prompts to the users for the users to answer;
f) scoring the responses provided by the users;
g) rewarding the winner of the game session after the end of the game session, wherein the winner is the user with the most correct responses.

7. The method of generating revenue according to claim 1, wherein the game uses trivia-based games.

8. The method of generating revenue according to claim 5, wherein the trivia-based games are music-related.

9. The method of generating revenue according to claim 5, wherein the trivia-based games are sports-related.

10. The method of generating revenue according to claim 2, wherein the revenue is generated by fee-based online advertising.

11. A system for computer-based gaming, comprising an internet-based computer game, hosted on a remote database and accessed via the Internet, which supplies the format to provide a multiplicity of skill- and knowledge-based games types playable by at least one remote user.

12. The system according to claim 11, wherein the internet-based computer game can be played simultaneously by at least two remote users.

13. The system according to claim 11, wherein the internet-based computer game can be played in a coordinated fashion by at least two remote users.

14. The system according to claim 11, wherein the internet-based computer game has a front end for the user interface and a back end for game operation.

15. The system according to claim 14, wherein the user interface provides interaction with the at least one remote user.

16. The system according to claim 15, wherein the interaction is composed of inputs by the at least one remote user and outputs by the system.

17. The system according to claim 15, wherein the interaction is composed of prompts by the system to the at least one remote user, inputs by the at least one remote user, and outputs by the system.

18. The system according to claim 14, wherein the user interface is provided via website access.

19. The system according to claim 14, wherein the user interface is provided via an ASP model.

20. The system according to claim 14, wherein the user interface is linked to at least one other website.

21. The system according to claim 14, wherein the user interface has visual components.

22. The system according to claim 14, wherein the user interface has audio components.

23. The system according to claim 14, wherein the user interface has audio and visual components.

24. The system according to claim 14, wherein the back end provides game rules.

25. The system according to claim 14, wherein the back end provides game scoring.

26. The system according to claim 14, wherein the back end provides game user history.

27. The system according to claim 14, wherein the back end provides different prompts.

28. The system according to claim 11, wherein the database provides accurate questions with answers.

29. The system according to claim 11, wherein the database provides a broad selection of trivia.

30. The system according to claim 29, wherein the broad selection of trivia includes a broad selection of categories.

31. The system according to claim 29, wherein the broad selection of trivia includes a broad selection of questions with answers.

32. The system according to claim 29, wherein the broad selection is so broad as to prevent repetition of questions.

33. The system according to claim 11, wherein the database is augmented continually.

34. The system according to claim 11, wherein the database provides text corresponding to a given game.

35. The system according to claim 11 wherein the database provides sound bytes.

36. The system according to claim 11, wherein the database provides visual clips.

37. The system according to claim 11, wherein the gametype is trivia-based.

38. The system according to claim 37, wherein the trivia-based gametype is genre-specific.
